(19) United States
(12) Patent Application Publication
(10) Pub. No.: US 2026/0170620 A1
(43) Pub. Date: Jun. 18, 2026

(54) IMAGE PROCESSING METHOD

(71) Applicant: TENCENT TECHNOLOGY (SHENZHEN) COMPANY LIMITED, Shenzhen (CN)

(72) Inventors: Hanzhong GUO, Shenzhen (CN); Wei LI, Shenzhen (CN); Sihong CHEN, Shenzhen (CN); Zhenxiang YAN, Shenzhen (CN)

(73) Assignee: TENCENT TECHNOLOGY (SHENZHEN) COMPANY LIMITED, Shenzhen, GD (CN)

(21) Appl. No.: 19/536,956

(22) Filed: Feb. 11, 2026

Related U.S. Application Data
(63) Continuation of application No. PCT/CN2024/114614, filed on Aug. 26, 2024.

(30) Foreign Application Priority Data
Nov. 7, 2023 (CN) 202311468616.7

(51) Int. Cl. G06T 5/70; G06T 5/20; G06T 11/60

(52) U.S. Cl. CPC G06T 5/70; G06T 5/20; G06T 11/60; G06T 2207/10024

(57) ABSTRACT

In an image processing method, an original image is obtained, a noise-added image is obtained through application of a forward diffusion network of a diffusion model to the original image based on sampled noise, and a denoised image is obtained through application of a reverse diffusion network of the diffusion model to the noise-added image. In the method, predicted noise is determined based on the denoised image, and a perturbation value is determined based on a noise prediction loss between the predicted noise and the sampled noise. In the method, an anti-editing image is determined through perturbation processing on the original image based on the perturbation value and a perturbation threshold.

### RELATED APPLICATIONS

The present application is a continuation of International Application No. PCT/CN2024/114614, filed on Aug. 26, 2024, which claims priority to Chinese Patent Application No. 202311468616.7, filed on Nov. 7, 2023 and entitled “IMAGE PROCESSING METHOD AND APPARATUS, DEVICE, AND STORAGE MEDIUM.” The entire disclosures of the prior applications are hereby incorporated by reference.

### FIELD OF THE TECHNOLOGY

This disclosure relates to the field of image processing technologies, including an image processing method and apparatus, a device, and a storage medium.

### BACKGROUND OF THE DISCLOSURE

With the generation of a large number of open-source large-scale text-to-image models, a threshold for editing (e.g., as source materials to be edited by an automated conversion tool or model) a picture posted on a network by a user has gradually decreased. Therefore, to protect the picture from being taken for editing, the picture may be processed in a manner to reduce a possibility of picture tampering.

In some applications, a style converter is used, and a gradient of the style converter is maximized, so that a latent space representing a picture style in an original picture is different from a picture style of another picture, thereby preventing the picture style from being edited.

However, in a case that the style converter cannot properly represent the picture style, the possibility that the picture is taken for editing (e.g., by an automated conversion tool or model) cannot be effectively reduced. It can be learned that the method for preventing the picture from being edited through the style converter can be applied to a specific set of scenarios, and cannot effectively reduce the possibility that the picture is taken for editing.

### SUMMARY

Embodiments of this disclosure provide an image processing method and apparatus, a device, and a storage medium, to increase difficulty for a diffusion model to learn an image feature in an anti-editing image and increase difficulty for the diffusion model to edit an anti-editing image. Embodiments of this disclosure are illustrated as follows.

According to an aspect, an embodiment of this disclosure provides an image processing method. In the method, an original image is obtained, a noise-added image is obtained by processing circuitry through application of a forward diffusion network of a diffusion model to the original image based on sampled noise, and a denoised image is obtained by the processing circuitry through application of a reverse diffusion network of the diffusion model to the noise-added image. In the method, predicted noise is determined based on the denoised image, and a perturbation value is determined based on a noise prediction loss between the predicted noise and the sampled noise. In the method, an anti-editing image is obtained by the processing circuitry through perturbation processing on the original image based on the perturbation value and a perturbation threshold.

According to an aspect, an embodiment of this disclosure provides an image processing apparatus. The apparatus includes processing circuitry configured to obtain an original image, obtain a noise-added image through application of a forward diffusion network of a diffusion model to the original image based on sampled noise, and obtain a denoised image through application of a reverse diffusion network of the diffusion model to the noise-added image. The processing circuitry is configured to determine predicted noise based on the denoised image and determine a perturbation value based on a noise prediction loss between the predicted noise and the sampled noise. The processing circuitry is configured to obtain an anti-editing image through perturbation processing on the original image based on the perturbation value and a perturbation threshold.

According to an aspect, an embodiment of this disclosure provides a non-transitory computer-readable storage medium storing instructions, which when executed by a processor, cause the processor to perform an image processing method. In the method, an original image is obtained, a noise-added image is obtained through application of a forward diffusion network of a diffusion model to the original image based on sampled noise, and a denoised image is obtained through application of a reverse diffusion network of the diffusion model to the noise-added image. In the method, predicted noise is determined based on the denoised image, and a perturbation value is determined based on a noise prediction loss between the predicted noise and the sampled noise. In the method, an anti-editing image is obtained through perturbation processing on the original image based on the perturbation value and a perturbation threshold.

According to an aspect, an embodiment of this disclosure provides an image processing method, performed by a computer device, and including: obtaining an original image; performing noise addition processing on the original image through a forward diffusion network of a diffusion model based on sampled noise, to obtain a noise-added image; performing denoising processing on the noise-added image through a reverse diffusion network of the diffusion model, and determining predicted noise based on a denoised image obtained through the denoising processing; determining a perturbation value based on a noise prediction loss between the predicted noise and the sampled noise; and performing perturbation processing on the original image based on the perturbation value, to obtain an anti-editing image.

According to another aspect, an embodiment of this disclosure provides an image processing apparatus, deployed on a computer device, and including: an obtaining module, configured to obtain an original image; a noise addition processing module, configured to perform noise addition processing on the original image through a forward diffusion network of a diffusion model based on sampled noise, to obtain a noise-added image; a noise prediction module, configured to perform denoising processing on the noise-added image through a reverse diffusion network of the diffusion model, and determine predicted noise based on a denoised image obtained through the denoising processing; a perturbation determining module, configured to determine a perturbation value based on a noise prediction loss between the predicted noise and the sampled noise; and a first perturbation processing module, configured to perform perturbation processing on the original image based on the perturbation value, to obtain an anti-editing image.

According to another aspect, an embodiment of this disclosure provides a computer device, including processing circuitry (such as a processor) and a memory, the memory having at least one instruction stored therein, the at least one instruction being configured for being executed by the processor to implement the image processing method in the foregoing aspects.

According to another aspect, an embodiment of this disclosure provides a non-transitory computer-readable storage medium, having at least one instruction stored therein, the at least one instruction being loaded and executed by processing circuitry (such as a processor) to implement the image processing method in the foregoing aspects.

According to another aspect, an embodiment of this disclosure provides a computer program product, including a computer instruction, the computer instruction being stored in a non-transitory computer-readable storage medium. Processing circuitry (such as a processor) of a computer device reads the computer instruction from the computer-readable storage medium. The processor executes the computer instruction, so that the computer device performs the image processing method provided in various examples of the foregoing aspects.

In some embodiments of this disclosure, after the original image is obtained, the noise addition processing is first performed on the original image through the forward diffusion network of the diffusion model based on the sampled noise, to obtain the noise-added image. Further, the denoising processing is performed on the noise-added image through the reverse diffusion network of the diffusion model, and the predicted noise is determined based on the denoised image obtained through denoising processing. The process in which the diffusion model performs noise addition processing and denoising processing on the original image corresponds to the process of performing image feature learning on the original image. However, the noise prediction loss between the predicted noise and the sampled noise may represent an uncertainty of the diffusion model for the noise in a current state. Therefore, the perturbation value may be determined based on the noise prediction loss between the predicted noise and the sampled noise. The perturbation value is intended to simulate or amplify an uncertainty of the diffusion model in the predicted noise. In this way, perturbation processing may be performed on the original image based on the perturbation value, to obtain an anti-editing image, thereby introducing an additional noise that is difficult to predict into the anti-editing image. In other words, signal interference is applied to each pixel point in the anti-editing image, thereby increasing the difficulty for the diffusion model to learn image feature of the anti-editing image. Correspondingly, in a case that image editing is performed on the anti-editing image through the trained diffusion model, because signal interference is applied to each pixel point in the anti-editing image, the diffusion model cannot accurately extract the image feature in the anti-editing image, thereby enhancing difficulty for the diffusion model to edit the anti-editing image.

### BRIEF DESCRIPTION OF THE DRAWINGS

To describe technical solutions of embodiments of this disclosure, drawings required for describing one or more embodiments are briefly described below. The drawings in the following description show only some embodiments of this disclosure, and a person of ordinary skill in the art can derive other drawings from the drawings.

FIG. 1 is a schematic structural diagram of a diffusion model according to an embodiment of this disclosure.

FIG. 2 is a schematic structural diagram of a low-rank adaptation (LoRA) according to an embodiment of this disclosure.

FIG. 3 is a schematic diagram of an image configured for LoRA fine tuning according to an embodiment of this disclosure.

FIG. 4 is a schematic diagram of a result of a picture edited by a diffusion model after LoRA fine tuning according to an embodiment of this disclosure.

FIG. 5 is a schematic diagram of an implementation environment according to an embodiment of this disclosure.

FIG. 6 is a flowchart of an image processing method according to an embodiment of this disclosure.

FIG. 7 is a flowchart of an image processing method according to another embodiment of this disclosure.

FIG. 8 is a contrast diagram of visual effects of an anti-editing image and an original image according to an embodiment of this disclosure.

FIG. 9 is a schematic diagram of a result of learning and editing an anti-editing image through a diffusion model according to an embodiment of this disclosure.

FIG. 10 is a schematic flowchart of obtaining an anti-editing image through M rounds of perturbation processing according to an embodiment of this disclosure.

FIG. 11 is a structural block diagram of an image processing apparatus according to an embodiment of this disclosure.

FIG. 12 is a schematic structural diagram of a computer device according to an embodiment of this disclosure.

### DESCRIPTION OF EMBODIMENTS

To describe objectives, technical solutions, and advantages of this disclosure, implementations of this disclosure are described in further details below with reference to drawings. Embodiments described should not be construed as a limitation on this disclosure. Other embodiments are within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

In some applications, to edit an image, a computer device usually trains a diffusion model through an image set having a target image feature, so that the diffusion model can edit another image through a learned target image feature.

In some embodiments, the diffusion model may include a text-to-image latent space model (Stable Diffusion, SD), a text-to-image cascade model (Deep Floyd IF), and the like.

In some embodiments, the diffusion model may learn an image feature by performing noise addition and denoising on the image, so that the diffusion model would implement noise addition and denoising on the image through one forward process and one reverse process. In other words, the diffusion model is configured to perform noise addition processing on the image through a forward diffusion network, and perform denoising processing on the noise-added image through a reverse diffusion network.

In some embodiments, a process in which the diffusion model performs the noise addition processing on the image may be represented as dxₜ=f(t)xₜdt+g(t)dw, and a denoising processing process may be represented as dxₜ=[f(t)xₜ−g(t)²∇ₓ_{ₜ} log q(xₜ)]dt+g(t)dŵ, where w represents a standard Wiener process (also referred to as a Brownian motion), f(t) is a drift coefficient of xₜ, g(t) is a diffusion coefficient of xₜ, xₜ is an image sample corresponding to a moment t, ŵ represents a standard Wiener process when a time flows back from T to 0, q(xₜ) is data distribution of xₜ, and ∇ₓ_{ₜ} log q(xₜ) represents a data distribution score.

In a process of performing the noise addition processing on the image, a diffusion duration is a continuous time variable t∈[0, T], a data distribution corresponding to a moment 0 may be represented as x₀−q(x₀), and a data distribution corresponding to a moment T may be represented as x_{T}−q(x_{T}). However, to learn the image feature, the computer device may perform a discretization reverse process to obtain a real sample x₀−q(x₀).

In an example of at least one aspect, as shown in FIG. 1, the computer device may first perform noise addition processing on an image through a forward diffusion network 102 in a diffusion model 101, to obtain a noise-added image, and perform denoising processing on the noise-added image through a reverse diffusion network 103.

In a possible implementation, the computer device may estimate ∇ₓ_{ₜ} log q(xₜ) by using a denoising score matching method through a prediction network. In this case, a target function J_{DSM}=E_{q(x}_{₀}_{)q(∈)ut)}{λₜ∥s_{θ}(xₜ, t)−∇ₓ_{ₜ} log q(xₜ|x₀)∥²}, where s_{θ} is a prediction network. In a process of training the diffusion model based on the target function, s_{θ}(xₜ, t)=∇ₓ_{ₜ} log q(xₜ) is satisfied in a case that the target function converges to an optimal point. Therefore, the computer device implements optimization training on the diffusion model.

To apply the diffusion model to generate a picture of a specific field, the computer device may perform further fine tuning on the diffusion model. In some embodiments, the computer device may perform fine tuning on the diffusion model through a low-rank adaption (LoRA) structure of a large language model.

In some embodiments, in a case that full parameter fine tuning is performed on the diffusion model, the LoRA may convert a W matrix on which a large parameter amount may be adjusted into two small matrixes A and B based on the formula f(X)=W′X+ΔW′X=W′X+(A′B)′X, so as to implement fitting of an image data set.

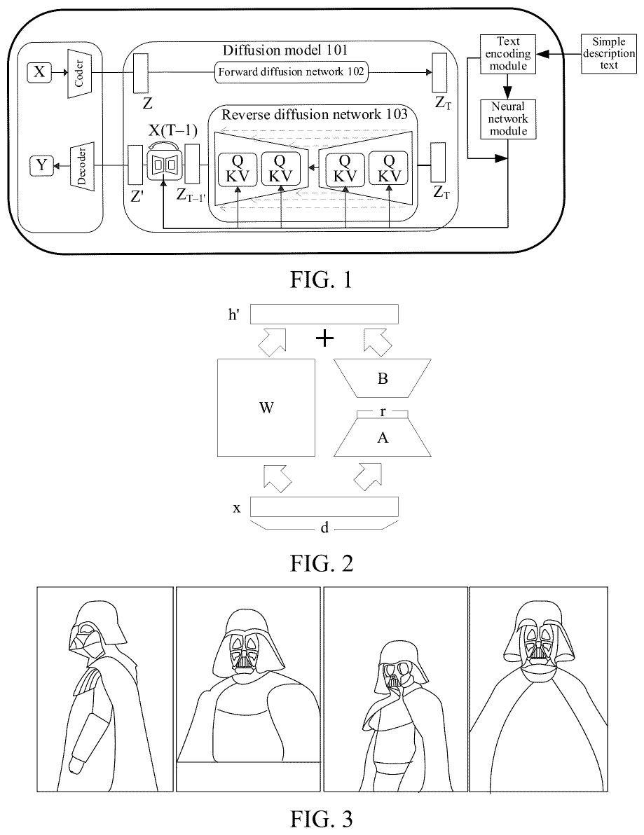

In an example of at least one aspect, as shown in FIG. 2, A is a matrix mapped from a dimension d to a dimension r, and B is a matrix mapped from a dimension r to a dimension d. The computer device may initialize the matrix A through random Gaussian distribution, initialize the matrix B through a zero matrix, and train only the matrix A and the matrix B during training. Therefore, after training is completed, a parameter of a pretrained model is combined by multiplying the matrix B with the matrix A as a model parameter after fine tuning.

In a possible implementation, at a stage of performing the fine tuning on the diffusion model, the computer device may train the diffusion model through a small number of image sets of a specific field. In some embodiments, a model training target function in the fine-tuning stage may be represented as J_{DSM}=E_{q(x}_{₀}_{)q(∈)u(t)}{λₜ|x_{θ}(xₜ, t, c)−∈ₓ_{ₜ} log q(xₜ|x₀, c)∥²}, where c represents a text description corresponding to an image.

In an example of at least one aspect, as shown in FIG. 1, the computer device may perform, through a neural network module and based on a simple description text corresponding to the image, noise prediction on a denoised image in a denoising process, so as to train the diffusion model based on predicted noise and a target function.

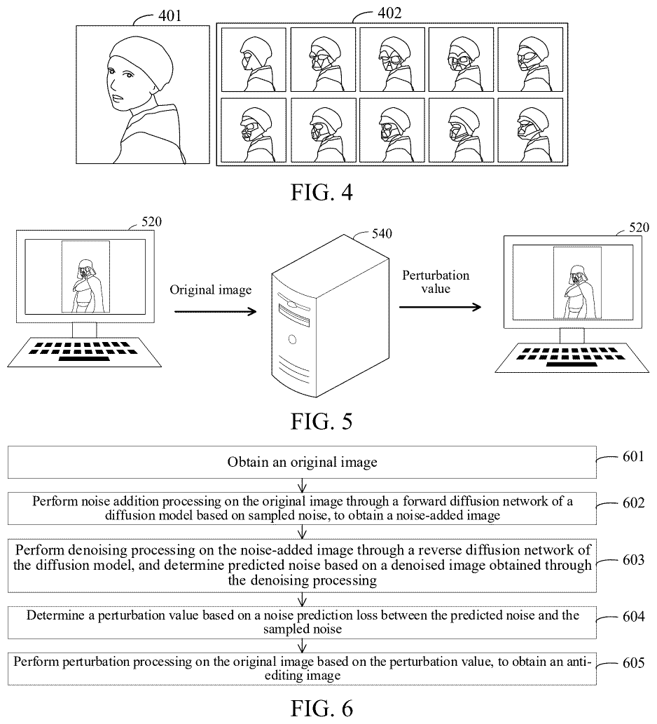

In an example of at least one aspect, FIG. 3 shows a group of image sets configured for LoRA fine tuning. After training and fine tuning are performed on the diffusion model through the image set shown in FIG. 3, the computer device may perform image editing on an image shown in 401 in FIG. 4 through the image feature learned by the diffusion model, so as to obtain an image shown in 402 in FIG. 4. Moreover, 402 includes a generated image outputted by the diffusion model that performs fine tuning based on different fine-tuning weights.

In some embodiments of this disclosure, to increase difficulty for the diffusion model to learn the image feature of the original image and prevent the original image from being learned and edited by the diffusion model, in a process of performing noise addition processing and denoising processing on the original image through the diffusion model, noise prediction is performed on the denoised image, to obtain predicted noise, so that a perturbation value is determined based on the noise prediction loss between the predicted noise and the sampled noise, and perturbation processing is performed on the original image through the perturbation value, to obtain an anti-editing image corresponding to the original image. Therefore, the diffusion model hardly learns the image feature from the anti-editing image, thereby increasing difficulty for the diffusion model to edit the anti-editing image.

In a possible implementation, considering that in some embodiments of this disclosure, to prevent the image feature of the original image from being learned and edited by the diffusion model, in a process of performing fine tuning on the diffusion model through the original image, a perturbation value is determined based on the noise prediction loss, and reverse perturbation processing is performed on the original image based on the perturbation value, to obtain the anti-editing image. Therefore, the target function in the process may be determined as

$${J}_{Adv} = {max}_{δ} {min}_{θ} {E}_{q ( {x}_{0} + δ ) q ( ϵ ) u ( t )} \{ {λ}_{t} {‖ {s}_{θ} ( {x}_{t}^{′} , t , c ) - {∇}_{{x}_{t}} log q ( {x}_{t}^{′} \vert {x}_{0} + δ , c ) ‖}^{2} \} ,$$

where δ is a perturbation value, s_{θ} is a prediction network, t is a sampling moment, c is a text description corresponding to an image, x₀ is an original image,

$${x}_{t}^{′}$$

is a noise image corresponding to the sampling moment, λₜ is an adjustment coefficient, and ∈ is Gaussian noise.

In other words, in a process of minimizing J_{DSM} by performing fine tuning on the diffusion model, in some embodiments of this disclosure, a maximum perturbation value δ is determined, so that perturbation processing is performed on the original image through the perturbation value, thereby increasing anti-editing effectiveness of the anti-editing image.

In a possible implementation, it is considered that different fine-tuning forms may be adopted in a process of performing fine tuning on the diffusion model. In other words, different prediction networks s_{θ} may be generated through different fine-tuning forms. Therefore, to improve efficiency of determining the perturbation value, approximate processing may be further performed on the target function. Namely, it is assumed that the diffusion model is already optimized, the target function may be approximately represented as

$${J}_{Adv} \approx {max}_{δ} {E}_{q ( {x}_{0} + δ ) q ( ϵ ) u ( t )} \{ {λ}_{t} {‖ {s}_{\hat{θ}} ( {x}_{t}^{′} , t , c ) - {∇}_{{x}_{t}} log q ( {x}_{t}^{′} \vert {x}_{0} + δ , c ) ‖}^{2} \} ,$$

where s_{\hat{θ}} represents a prediction network in the diffusion model on which pretraining processing is performed.

In some embodiments, the prediction network in the diffusion model may be a score network, a noise network, or a v-network. Information expressed by different prediction networks in a process of training a target function is the same, and is a direction in which a probability density of data expressed in different dimensions increases fastest, where the noise network and the score network satisfy

$${ϵ}_{θ} ( {x}_{t}^{′} , t , c ) = - {σ}_{t} {s}_{θ} ( {x}_{t}^{′} , t , c ) = - {σ}_{t} {∇}_{{x}_{t}} log q ( {x}_{t} ) .$$

In other words, output data of the noise network and the score network may be mutually converted based on a linear relationship.

FIG. 5 is a schematic diagram of an implementation environment according to an embodiment of this disclosure. The implementation environment includes a terminal 520 and a server 540. The terminal 520 performs data communication with the server 540 through a communication network. In some embodiments, the communication network may be a wired network or a wireless network, and the communication network may be at least one of a local area network, a metropolitan area network, and a wide area network.

The terminal 520 is an electronic device on which an application program having an image processing function is installed. The image processing function may be a function of a native application in the terminal, or a function of a third-party application. The electronic device may be a smartphone, a tablet computer, a personal computer, a wearable device, an on-board terminal, or the like. In FIG. 5, a description is provided by using an example in which the terminal 520 is the personal computer, but this is not limited thereto.

The server 540 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. In some embodiments of this disclosure, the server 540 may be a backend server of an application having an image processing function.

In a possible implementation, as shown in FIG. 5, the server 540 exchanges data with the terminal 520. After the terminal 520 obtains the original image, the terminal 520 transmits the original image to the server 540. Therefore, the server 540 performs noise addition processing on the original image based on the sampled noise through a forward diffusion network of a diffusion model, to obtain a noise-added image, and performs denoising processing on the noise-added image through a reverse diffusion network of the diffusion model, so as to perform noise prediction on a denoised image obtained through denoising processing, to obtain predicted noise, and further determine a perturbation value based on a noise prediction loss between the sampled noise and the predicted noise, thereby transmitting the perturbation value to the terminal 520. The terminal 520 performs perturbation processing on the original image based on the perturbation value, so as to obtain an anti-editing image.

FIG. 6 is a flowchart of an image processing method according to an embodiment of this disclosure. This embodiment is described by using an example in which the method is applied to a computer device (including a terminal 520 and/or a server 540). The method includes the following operations.

Operation 601: Obtain an original image.

In some embodiments, the original image is a two-dimensional digital matrix formed by pixels.

In some embodiments, the original image may be red-green-blue (RGB) image data. In other words, each pixel point respectively corresponds to three color channels. The original image may also be image data that is obtained by performing channel combination on the RGB image and normalizing the image data to a floating-point number ranging from 0 to 1.

Operation 602: Perform noise addition processing on the original image through a forward diffusion network of a diffusion model based on sampled noise, to obtain a noise-added image. For example, a noise-added image is obtained by processing circuitry through application of a forward diffusion network of a diffusion model to the original image based on sampled noise.

In some embodiments, after the original image is obtained, the computer device may perform noise addition processing on the original image through the forward diffusion network of the diffusion model based on the sampled noise, so as to obtain the noise-added image.

In a possible implementation, the computer device encodes the original image through an encoding and decoding module in the diffusion model, and compresses the original image from a pixel space to a latent space, thereby performing noise addition processing on the original image through the forward diffusion network based on the sampled noise, to obtain the noise-added image.

In some embodiments, the sampled noise is a type of signal interference applied to the original image, and may cause image information or pixel brightness of the original image to change. In some embodiments, the sampled noise may be various types of noise. For example, the sampled noise may be Gaussian noise, impulse noise, or the like. When the sampled noise is the Gaussian noise, each pixel point in the noise-added image is a pixel point to which noise is applied.

In some embodiments, the noise-added image is an image to which signal interference is applied. Compared with the original image, the image information or the pixel brightness in the noise-added image has been changed.

In some embodiments, a process of performing noise addition processing on the original image through the forward diffusion network is a process of applying signal interference to each pixel point in the original image through the sampled noise. The original image may be represented as x₀, the sampled noise may be represented as ∈, and the diffusion duration may be represented as T, so that the computer device applies noise to each pixel point in the original image through the forward diffusion network based on the sampled noise during the continuous diffusion duration T, to obtain a noise-added image x_{T}. Moreover, the noise-added image x_{T} may be a pure noise image.

Operation 603: Perform denoising processing on the noise-added image through a reverse diffusion network of the diffusion model, and determine predicted noise based on a denoised image obtained through the denoising processing. For example, a denoised image is obtained by the processing circuitry through application of a reverse diffusion network of the diffusion model to the noise-added image. In some examples, predicted noise is determined based on the denoised image.

In some embodiments, after the noise-added image is obtained by performing the noise addition processing on the original image, to enable the diffusion model to learn the image feature in the original image, the computer device may continue to perform denoising processing on the noise-added image through the reverse diffusion network in the diffusion model, to obtain the denoised image. In some embodiments, the reverse diffusion network may be a U-net network.

In some embodiments, a process of performing denoising processing on the noise-added image through the reverse diffusion network is a process of removing signal interference applied to each pixel point in the noise-added image. In this process, to restore the original image, the reverse diffusion network may learn the image feature, and predict noise applied to the noise-added image, to implement denoising on the noise-added image. The diffusion duration in the denoising process is also T, namely, a reverse diffusion process from x_{T} to x₀.

In some embodiments, in a process of performing inverse denoising on the noise-added image, to enable the denoised image and the original image to have the same data distribution, the computer device may perform noise prediction on the denoised image through a neural network in a denoising process, for subsequent loss calculation.

In some embodiments, the predicted noise refers to noise data obtained by predicting signal interference applied to the noise-added image. The prediction process may be implemented through a prediction network in a process of denoising the noise-added image.

In a possible implementation, the computer device may predict the denoised image through the prediction network, to obtain the predicted noise. In some embodiments, the prediction network may be a score network, a noise network, a V-network, or the like, which is not limited in some embodiments of this disclosure.

Operation 604: Determine a perturbation value based on a noise prediction loss between the predicted noise and the sampled noise.

In some embodiments, because the process in which the diffusion model performs noise addition processing and denoising processing on the original image corresponds to the process of learning the image feature of the original image, the computer device may calculate the noise prediction loss based on the predicted noise and the sampled noise, so that the diffusion model sufficiently learns the image feature of the original image based on the noise prediction loss.

However, in some embodiments of this disclosure, to prevent the image feature of the original image from being learned by the diffusion model, the computer device may reversely determine the perturbation value based on the noise prediction loss after the noise prediction loss is determined, so that the diffusion model hardly learns the image feature of the original image through the perturbation value.

In some embodiments, the noise prediction loss is a result of performing norm calculation on a noise difference between the predicted noise and the sampled noise. The noise difference is a difference between a signal interference value actually applied to each pixel point in an image and a predicted signal interference value.

In some embodiments, the perturbation value is configured for indicating an amount of adjustment to a RGB value of each pixel point in the original image, and may be a perturbation signal applied to each pixel point in the original image. The image feature represented by each pixel point in the original image may be protected based on the perturbation signal.

In some embodiments, in a process of training the diffusion model based on the noise prediction loss, a smaller noise prediction loss indicates more effective training of the diffusion model, and easier learning of the image feature by the diffusion model. To cause the diffusion model unable to learn the image feature of the original image, or increase difficulty for the diffusion model to learn the feature of the original image, the computer device may inversely determine the perturbation value applied to the original image based on the noise prediction loss. The noise prediction loss is positively correlated with the perturbation value, and a larger noise prediction loss indicates a larger perturbation value.

Operation 605: Perform perturbation processing on the original image based on the perturbation value, to obtain an anti-editing image. For example, an anti-editing image is obtained by the processing circuitry through perturbation processing on the original image based on the perturbation value and a perturbation threshold.

In some embodiments, after the perturbation value corresponding to the original image is determined, the computer device may perform perturbation processing on the original image based on the perturbation value, to obtain an anti-editing image, so that the diffusion model hardly learns the image feature in the original image through the anti-editing image.

In some embodiments, the perturbation value and the original image have the same data expression form, and the perturbation value is in a form of a matrix. Each perturbation value in the matrix respectively corresponds to each pixel point in the image. In other words, the process of performing perturbation processing on the original image based on the perturbation value is a process of performing perturbation on each pixel point of the original image.

In some embodiments, the process of performing perturbation processing on the original image is a process of applying the perturbation signal to each pixel point in the original image, and different perturbation values may correspond to different pixel points. Therefore, when the diffusion model performs image feature learning on the anti-editing image through noise addition processing and denoising processing, the perturbation value applied to each pixel point in the anti-editing image affects the noise prediction result of the diffusion model, thereby increasing difficulty for the diffusion model to learn the image feature of the anti-editing image.

Based on the above, in some embodiments of this disclosure, after the original image is obtained, the noise addition processing is first performed on the original image through the forward diffusion network of the diffusion model based on the sampled noise, to obtain the noise-added image. Further, the denoising processing is performed on the noise-added image through the reverse diffusion network of the diffusion model, and the predicted noise is determined based on the denoised image obtained through denoising processing. The process in which the diffusion model performs noise addition processing and denoising processing on the original image corresponds to the process of performing image feature learning on the original image. However, the noise prediction loss between the predicted noise and the sampled noise may represent an uncertainty of the diffusion model for the noise in a current state. Therefore, the perturbation value may be determined based on the noise prediction loss between the predicted noise and the sampled noise. The perturbation value is intended to simulate or amplify an uncertainty of the diffusion model in the predicted noise. In this way, perturbation processing may be performed on the original image based on the perturbation value, to obtain an anti-editing image, thereby introducing an additional noise that is difficult to predict into the anti-editing image. In other words, signal interference is applied to each pixel point in the anti-editing image, thereby increasing the difficulty for the diffusion model to learn image feature of the anti-editing image. Correspondingly, in a case that image editing is performed on the anti-editing image through the trained diffusion model, because signal interference is applied to each pixel point in the anti-editing image, the diffusion model cannot accurately extract the image feature in the anti-editing image, thereby enhancing difficulty for the diffusion model to edit the anti-editing image.

In some embodiments, to improve accuracy of determining the perturbation value, the computer device may further perform random uniform sampling on a time within the diffusion duration, to determine a sampling moment, so as to perform noise prediction based on the denoised image corresponding to the sampling moment, and then determine the perturbation value.

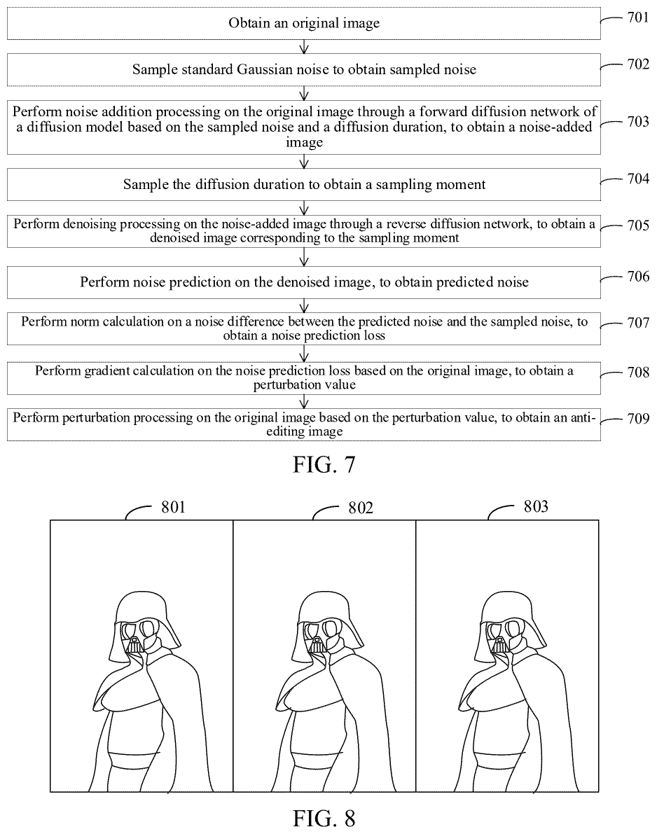

FIG. 7 is a flowchart of an image processing method according to an embodiment of this disclosure. This embodiment is described by using an example in which the method is applied to a computer device (including a terminal 520 and/or a server 540). The method includes the following operations.

Operation 701: Obtain an original image.

Operation 702: Sample standard Gaussian noise to obtain sampled noise.

In a possible implementation, the computer device performs noise sampling on the noise satisfying a standard Gaussian distribution, so as to obtain the sampled noise, namely, the Gaussian noise.

In some embodiments, a noise sampling process may be represented as ∈− [symbol] (0, E), where ∈ is the Gaussian noise.

Operation 703: Perform noise addition processing on the original image through a forward diffusion network of a diffusion model based on the sampled noise and a diffusion duration, to obtain a noise-added image. For example, the noise-added image is obtained through the application of the forward diffusion network based on the sampled noise and a diffusion duration.

In some embodiments, the computer device may preset a diffusion duration corresponding to the diffusion model. The noise-added images obtained through different diffusion durations have different noise distributions.

In a possible implementation, the computer device performs noise addition processing on the original image through the forward diffusion network of the diffusion model based on the sampled noise and the diffusion duration, so as to obtain the noise-added image.

In some embodiments, the diffusion duration may be represented as T, the noise addition process may be represented as q(xₜ|xₜ₋₁), xₜ is a corresponding noise-added image when the noise addition duration is t, t∈[0, T], and xₜ may be represented as xₜ=aₜx₀+σₜ∈, where aₜ and σₜ represent a discretization situation in a noise addition process, x₀ is an original image, and ∈ is Gaussian noise.

In a possible implementation, before performing noise addition processing on the original image through the diffusion model, to improve accuracy of determining the perturbation value, the computer device may further train the original diffusion model through a sample image set, to obtain a trained diffusion model, so as to perform the noise addition processing on the original image through the trained diffusion model.

In some embodiments, to enable a prediction network in the diffusion model to accurately perform noise prediction on the denoised image based on a text description, the sample image set include at least one sample image having a similar image feature to the original image, so that the diffusion model sufficiently learns the image feature.

For example, in a case that the original image is a kitten image, the sample image set includes at least several sample images having the cat feature.

Operation 704: Sample the diffusion duration to obtain a sampling moment.

In a possible implementation, to perform noise prediction based on a denoised image corresponding to a denoising duration (e.g., a random denoising duration) in a denoising process, the computer device may further sample the diffusion duration, and determine the sampling moment.

In some embodiments, a process of determining the sampling moment may be represented as t−U(T), where T is the diffusion duration.

In some embodiments, in the denoising process, the computer device may sample the diffusion duration for a single time, to obtain a single sampling moment. The computer device may further sample the diffusion duration for a plurality of times, to obtain a plurality of sampling moments.

Operation 705: Perform denoising processing on the noise-added image through a reverse diffusion network, to obtain a denoised image corresponding to the sampling moment. For example, the denoised image corresponding to the sampling moment is obtained through the application of the reverse diffusion network.

In some embodiments, after the sampling moment is determined, the computer device may determine the denoised image corresponding to the sampling moment in a process of performing denoising processing on the noise-added image through the reverse diffusion network.

In a possible implementation, the sampling moment is t. Then, the computer device may determine the image at a moment T−t after the denoising duration as the denoised image.

In a possible implementation, in a case that the diffusion duration is sampled for a single time, the computer device obtains the denoised image corresponding to the single sampling moment. In a case that the diffusion duration is sampled for a plurality of times, the computer device obtains the denoised image corresponding to each sampling moment.

In some embodiments, to enable the diffusion model to learn a specific image feature, in the process of performing denoising processing on the noise-added image through the reverse diffusion network, the computer device may further perform denoising processing on the noise-added image with reference to a text feature of the image.

In a possible implementation, the computer device performs denoising processing on the noise-added image based on the text description of the original image through the reverse diffusion network, so as to obtain the denoised image corresponding to the sampling moment. For example, the denoised image corresponding to the sampling moment is obtained through the application of the reverse diffusion network based on a text description of the original image.

In some embodiments, the computer device inputs the text description into the reverse diffusion network of the diffusion model, so that the reverse diffusion network may perform denoising processing on pixel points of different image regions in the noise-added image based on the text description, so as to obtain the denoised image corresponding to the sampling moment. For example, if the text description is “a cat exists in the middle of the image”, the reverse diffusion network may perform fine denoising processing on a middle region of the image.

In some embodiments, the computer device may perform text feature extraction on the original image through a bootstrapping language-image pretraining (BLIP) model, so as to obtain a text description corresponding to the original image.

Operation 706: Perform noise prediction on the denoised image, to obtain predicted noise.

In a possible implementation, after the denoised image corresponding to the sampling moment is determined, the computer device may perform noise prediction on the denoised image through the prediction network, to obtain the predicted noise.

In some embodiments, the computer device may perform noise prediction on the denoised image through a noise network in the diffusion model, and output the predicted noise through the noise network. The process may be represented as ∈_{\hat{θ}}(xₜ, t, c), where ∈_{\hat{θ}} is a noise network when the diffusion model is trained to be optimal, c is a text description corresponding to the original image, and xₜ is a denoised image corresponding to the sampling moment t.

In a possible implementation, in a case that the diffusion duration is sampled for a single time, the computer device obtains the denoised image corresponding to the single sampling moment, and performs noise prediction on the single denoised image, to obtain single predicted noise. In a case that the diffusion duration is sampled for a plurality of times, the computer device obtains the denoised image corresponding to each sampling moment, and performs noise prediction on each denoised image, to obtain each corresponding predicted noise.

In a possible implementation, considering that in some embodiments of this disclosure, an objective of obtaining the denoised image is to further determine the noise prediction loss by performing noise prediction on the denoised image. In other words, in some embodiments of this disclosure, the noise-added image obtained after the noise addition through an entire diffusion duration T may not be needed. Therefore, to improve image processing efficiency, the computer device may further sample the diffusion duration first, determine the sampling moment, and further perform noise addition processing on the original image based on the sampling moment directly through the forward diffusion network of the diffusion model, so as to obtain the noise-added image xₜ, and perform noise prediction to obtain the predicted noise based on the noise-added image xₜ through the noise network.

Operation 707: Perform norm calculation on a noise difference between the predicted noise and the sampled noise, to obtain a noise prediction loss. For example, the noise prediction loss is determined based on a norm calculation of a noise difference between the predicted noise and the sampled noise.

In some embodiments, after the predicted noise corresponding to the denoised image is obtained, the computer device may calculate a noise difference between the predicted noise and the sampled noise, and perform norm calculation on the noise difference, to obtain the noise prediction loss. The norm calculation is an important concept in mathematics, and is mainly configured for measuring a size or a length of a vector, a matrix, or another mathematical object. A plurality of types of norm calculation may be included, for example, one-norm calculation, two-norm calculation, and the like.

In a possible implementation, the computer device may perform the two-norm calculation on the noise difference, to obtain the noise prediction loss. In some embodiments, the process may be represented as Loss=∥∈_{\hat{θ}}(xₜ, t, c)∈∈∥², where ∈_{\hat{θ}}(xₜ, t, c) is the predicted noise, ∈ is the sampled noise, and the noise difference is ∈_{\hat{θ}}(xₜ,t,c)−∈.

In a possible implementation, in a case that the diffusion duration is sampled for a single time, after the predicted noise of the single denoised image is determined, the computer device may perform norm calculation on the noise difference between the predicted noise and the sampled noise, to obtain the noise prediction loss. In a case that the diffusion duration is sampled for a plurality of times, after the predicted noise of each denoised image is obtained, the computer device may respectively perform norm calculation on the noise differences between the predicted noise and the sampled noise, and obtain the noise prediction loss through averaging.

Operation 708: Perform gradient calculation on the noise prediction loss based on the original image, to obtain a perturbation value. For example, the perturbation value is obtained based on a gradient calculation of the noise prediction loss with respect to the original image.

In a possible implementation, to determine the perturbation value, the computer device may perform gradient calculation on the noise prediction loss based on the original image, to obtain the perturbation value corresponding to the original image. Performing gradient calculation on the noise prediction loss may refer to calculating a partial derivative of the noise prediction loss on an independent variable thereof.

In some embodiments, if the noise prediction loss is expressed as Loss and the independent variable thereof is x₀, a process of performing gradient calculation on the noise prediction loss may be represented a

$$δ = \frac{\partial Loss}{\partial {x}_{0}} ,$$

where x₀ is the original image and δ is the perturbation value.

Operation 709: Perform perturbation processing on the original image based on the perturbation value, to obtain an anti-editing image.

In some embodiments, to provide the anti-editing image having the same visual effect as the original image and avoid a visual difference caused in a process of performing perturbation processing on the original image based on the perturbation value, the computer device may further set a perturbation threshold, so as to perform perturbation processing on the original image based on the perturbation value to obtain the anti-editing image in a case that it is determined that a perturbation threshold condition is satisfied based on the perturbation value and the perturbation threshold, and to perform perturbation processing on the original image based on the perturbation threshold to obtain the anti-editing image in a case that it is determined that the perturbation threshold condition is not satisfied based on the perturbation value and the perturbation threshold.

In some embodiments, the perturbation threshold condition may be represented as ∥x₀+δ−x₀∥^{p}<δ₀, where δ₀ is the perturbation threshold, and δ is the perturbation value.

In a possible implementation, to improve an anti-editing degree of the anti-editing image and effectively protect an image feature of the original image, the computer device may further perform a plurality of rounds of perturbation processing on the original image based on the perturbation value, so as to obtain the anti-editing image.

In an example of at least one aspect, in FIG. 8, a right side is an original image 803, and a left side is an anti-editing image 801 obtained by performing perturbation processing on the original image 803. It can be seen that a relatively small visual difference exists between the anti-editing image 801 and the original image 803. A picture 802 obtained after the anti-editing image 801 is edited through a diffusion model is shown in a middle of FIG. 8. It can be seen that the edited picture 802 and the anti-editing image 801 are substantially the same, and the diffusion model hardly edits the anti-editing image 801.

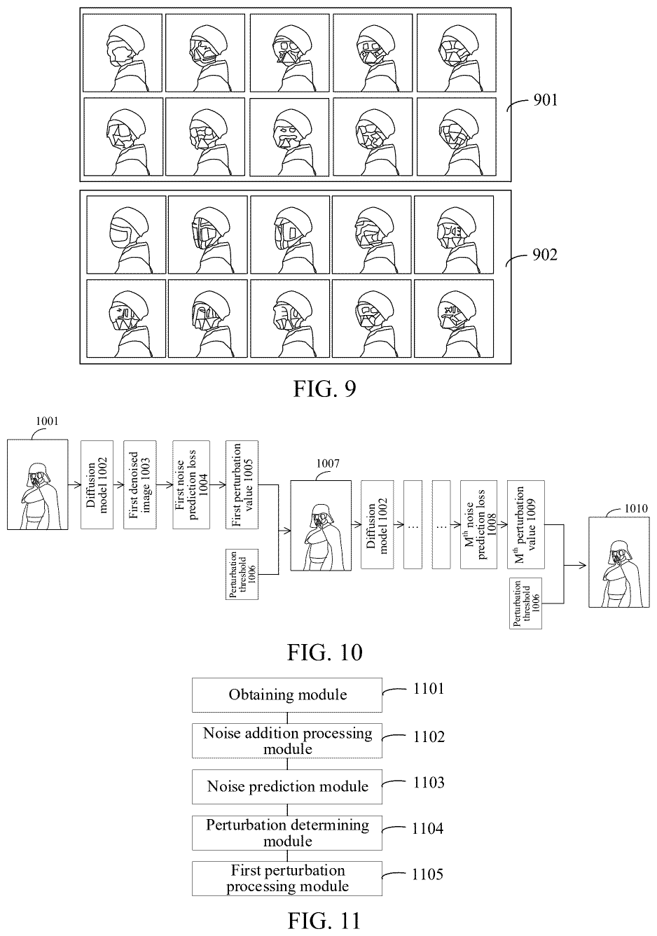

In an example of at least one aspect, as shown in FIG. 9, 901 in FIG. 9 is an image set obtained after anti-editing processing is performed based on different fine-tuning weights, and 902 in FIG. 9 is a result image obtained after the anti-editing image in 901 is edited based on different fine-tuning weights through the diffusion model. It can be seen that the result image has no image that is successfully edited. In other words, the diffusion model cannot perform image editing on the image obtained through the anti-editing processing.

In the foregoing embodiments, the sampling moment is determined by sampling the diffusion duration, so that noise prediction is performed on the denoised image corresponding to the sampling moment through the noise network, to obtain the predicted noise, and further the perturbation value is determined based on the noise prediction loss between the predicted noise and the sampled noise, thereby improving accuracy of determining the perturbation value and effectively increasing difficulty for the diffusion model to edit the anti-editing image.

In some embodiments, in a process in which the diffusion model performs image feature learning on the original image, the diffusion model may perform denoising processing by performing a plurality of rounds of noise addition processing on the original image, so as to perform optimization training based on each round of noise prediction loss. Therefore, correspondingly, in some embodiments of this disclosure, to improve anti-editing quality of the anti-editing image, the computer device may determine the perturbation value based on each round of noise prediction loss, so as to perform M rounds of perturbation processing on the original image, and determine, as the anti-editing image, a perturbed image obtained from the M^{th} round of perturbation processing.

In a possible implementation, the i^{th} round of perturbation processing among the M rounds of perturbation processing may include the following operations (not shown in the figure).

Operation 709a: Perform noise addition processing on an (i−1)^{th} perturbed image through the forward diffusion network based on i^{th} sampled noise, to obtain an i^{th} noise-added image, the (i−1)^{th} perturbed image being a perturbed image obtained through an (i−1)th round of perturbation processing.

In a possible implementation, when the i^{th} round of perturbation processing is performed, the computer device performs an i^{th} round of noise sampling on the noise conforming to a standard Gaussian distribution, to obtain i^{th} sampled noise, so as to perform noise addition processing on an (i−1)^{th} perturbed image through the forward diffusion network of the diffusion model based on the i^{th} sampled noise, to obtain an i^{th} noise-added image, where the (i−1)th perturbed image is a perturbed image obtained through an (i−1)^{th} round of perturbation processing, i being a positive integer greater than 1 and less than or equal to M.

Operation 709b: Perform denoising processing on the i^{th} noise-added image through the reverse diffusion network, and determine i^{th} predicted noise based on the i^{th} denoised image obtained through denoising. For example, an i^{th} denoised image is obtained through application of the reverse diffusion network of the diffusion model to the i^{th} noise-added image.

In a possible implementation, after the i^{th} noise-added image is obtained, the computer device may perform denoising processing on the i^{th} noise-added image through the reverse diffusion network, so as to obtain the i^{th} denoised image, and then perform noise prediction on the i^{th} denoised image through the noise network, to obtain the i^{th} predicted noise.

Operation 709c: Determine an i^{th} perturbation value based on an i^{th} noise prediction loss between the i^{th} predicted noise and the i^{th} sampled noise.

In a possible implementation, after the i^{th} predicted noise is obtained, the computer device may perform norm calculation on the noise difference between the i^{th} predicted noise and the i^{th} sampled noise, to obtain the i^{th} noise prediction loss. Moreover, to improve accuracy of determining the perturbation value in each round, the computer device may perform gradient calculation on the i^{th} noise prediction loss based on the (i−1)^{th} perturbed image, to obtain the i^{th} perturbation value.

In some embodiments, the (i−1)^{th} perturbed image may be represented as xᵢ₋₁, and a process of performing gradient calculation on the noise prediction loss may be represented as

$${δ}_{i} = \frac{\partial Loss}{\partial {x}_{i - 1}} .$$

Operation 709d: Perform perturbation processing on the (i−1)^{th} perturbed image based on the i^{th} perturbation value to obtain an i^{th} perturbed image if it is determined based on the i^{th} perturbation value and a perturbation threshold that a perturbation threshold condition is satisfied. For example, an i^{th} perturbed image is obtained through perturbation processing on the (i−1)^{th} perturbed image based on the i^{th} perturbation value when the i^{th} perturbation value and the perturbation threshold satisfying a perturbation threshold condition.

In some embodiments, to provide the anti-editing image having the same visual effect as the original image and avoid a visual difference caused in a process of performing perturbation processing on the original image based on the perturbation value, the computer device may further set a perturbation threshold, and perform condition determining on each round of perturbation value in each round of perturbation processing process. Therefore, in a case that it is determined that a perturbation threshold condition is satisfied based on the i^{th} perturbation value and a perturbation threshold, the computer device further performs perturbation processing on the (i−1)^{th} perturbed image based on the i^{th} perturbation value, to obtain an i^{th} perturbed image.

In some embodiments, an objective of setting the perturbation threshold condition is based on that the perturbed image obtained through each round of perturbation processing has a small visual difference with the original image, and has the same visual effect as the original image as much as possible. In a case that perturbation processing is performed on the original image based on the perturbation threshold, the perturbed image may keep having the same visual effect as the original image. In a case that perturbation processing is performed on the original image based on a perturbation value greater than the perturbation threshold, the perturbed image cannot keep having the same visual effect as the original image.

In some embodiments, the computer device may simulate in advance that perturbation processing is performed on the (i−1)^{th} perturbed image through the i^{th} perturbation value, to obtain an i^{th} candidate perturbed image, so as to determine whether the perturbation threshold condition is satisfied based on a visual difference between the i^{th} candidate perturbed image and the original image.

In a possible implementation, the computer device may first perform perturbation processing on the (i−1)^{th} perturbed image through the i^{th} perturbation value, to obtain the i^{th} candidate perturbed image, determine an i^{th} perturbation difference based on the i^{th} candidate perturbed image and the original image, and then perform norm calculation on the i^{th} perturbation difference, to obtain an i^{th} perturbation norm. The i^{th} perturbation difference is configured for representing a visual difference between the i^{th} candidate perturbed image and the original image, to compare the i^{th} perturbation norm with the perturbation threshold. In a case that the i^{th} perturbation norm is not greater than the perturbation threshold, the computer device may determine the i^{th} candidate perturbed image as the i^{th} perturbed image. The i^{th} candidate perturbed image is obtained by performing perturbation processing on the (i−1)^{th} perturbed image through the i^{th} perturbation value. Therefore, in a case that the perturbation threshold condition is satisfied, perturbation processing is performed on the (i−1)^{h} perturbed image based on the i^{th} perturbation value, to obtain the i^{th} perturbed image.

In some embodiments, the i^{th} perturbation norm may be a two-norm of the i^{th} perturbation difference, or may be an infinite norm of the i^{th} perturbation difference. In other words, the perturbation threshold condition may be that the two-norm of the i^{th} perturbation difference is not greater than the perturbation threshold, or may be that the infinite norm of the i^{th} perturbation difference is not greater than the perturbation threshold. In a case that the perturbation threshold condition is that the infinite norm of the i^{th} perturbation difference is not greater than the perturbation threshold, a smaller visual difference between the anti-editing image and the original image exists.

Operation 709e: Perform perturbation processing on the original image based on the perturbation threshold to obtain the i^{th} perturbed image if it is determined based on the i^{th} perturbation value and the perturbation threshold that the perturbation threshold condition is not satisfied. For example, the i^{th} perturbed image is obtained through perturbation processing on the original image based on the perturbation threshold when the i^{th} perturbation value and the perturbation threshold do not satisfy the perturbation threshold condition.

In a possible implementation, based on that each round of perturbed image may keep the same visual effect as the original image, the computer device may directly perform perturbation processing on the original image based on the perturbation threshold in a case that it is determined that a perturbation threshold condition is not satisfied based on the i^{th} perturbation value and the perturbation threshold, to obtain the i^{th} perturbed image.

In a possible implementation, the computer device first performs perturbation processing on the (i−1)^{th} perturbed image through the i^{th} perturbation value, to obtain the i^{th} candidate perturbed image, determines an i^{th} perturbation difference based on the i^{th} candidate perturbed image and the original image, and then performs norm calculation on the i^{th} perturbation difference, to obtain an i^{th} perturbation norm. Therefore, in a case that the i^{th} perturbation norm is greater than the perturbation threshold, the computer device may perform perturbation processing on the original image based on the perturbation threshold, to obtain the i^{th} perturbed image.

In some embodiments, in a process of performing norm calculation on the i^{th} perturbation difference, the computer device may calculate a 2-norm value or an infinite norm value of the i^{th} perturbation difference, which is not limited in some embodiments of this disclosure.

In a possible implementation, to improve visual effect consistency between the anti-editing image and the original image, the computer device may calculate an infinite norm for the i^{th} perturbation difference, to obtain the i^{th} perturbation norm.

In some embodiments, a process of determining whether the i^{th} perturbation value satisfies the perturbation threshold condition may be represented as

$$Clip ( {‖ {x}_{0}^{i - 1} + {δ}_{i} - {x}_{0} ‖}^{p} , {δ}_{0} ) ,$$

where x₀ is an original image, δᵢ is an i^{th} perturbation value,

$${x}_{0}^{i - 1}$$

is an (i−1)^{th} round of perturbed image,

$${x}_{0}^{i - 1} + {δ}_{i}$$

is an i^{th} round of candidate perturbed image, δ₀ is a perturbation threshold, and p may be an nhnite norm. Further, in a case that

$${‖ {x}_{0}^{i - 1} + {δ}_{i} - {x}_{0} ‖}^{p}$$

is not greater than δ₀,

$${x}_{0}^{i} = {x}_{0}^{i - 1} + {δ}_{i} .$$

In a case that

$${‖ {x}_{0}^{i - 1} + {δ}_{i} - {x}_{0} ‖}^{p}$$

is greater than δ₀,

$${x}_{0}^{i} = {x}_{0} + {δ}_{0} .$$

In the foregoing embodiments, M rounds of perturbation processing is performed on the original image, and the perturbation threshold condition is determined for the i^{th} perturbation value after the i^{th} perturbation value is determined in each round of perturbation processing, so as to determine a perturbed image obtained from each round of perturbation processing. A plurality of rounds of perturbation processing is performed on the original image, and a perturbed image obtained from a final round of perturbation processing is used as an anti-editing image, thereby improving an anti-editing degree of the anti-editing image and reducing a visual difference between the anti-editing image and the original image.

FIG. 10 is a schematic flowchart of obtaining an anti-editing image through M rounds of perturbation processing according to an embodiment of this disclosure.

As shown in FIG. 10, a computer device first inputs an original image 1001 into a diffusion model 1002, and then obtains a first denoised image 1003 through noise addition processing and denoising processing of the diffusion model 1002. Therefore, noise prediction is performed on the first denoised image 1003, to obtain first predicted noise. Further, a first noise prediction loss 1004 may be calculated based on the first sampled noise and the first predicted noise, to determine a first perturbation value 1005.

Next, to reduce a visual difference between an original image and an anti-editing image, the computer device may determine whether a perturbation threshold condition is satisfied based on the first perturbation value 1005 and a perturbation threshold 1006. The computer device performs perturbation processing on the original image 1001 through the first perturbation value 1005 in a case that the perturbation threshold condition is satisfied, to obtain a first perturbed image 1007. The computer device performs perturbation processing on the original image 1001 through the perturbation threshold 1006 in a case that the perturbation threshold condition is not satisfied, to obtain the first perturbed image 1007.

Then, after the first perturbed image 1007 is obtained, the computer device continues to input the first perturbed image 1007 into the diffusion model 1002, to perform a plurality of rounds of perturbation processing in the same process as the first round of perturbation processing.

Finally, after an M^{th} noise prediction loss 1008 is obtained through an M^{th} round of noise prediction, the computer device may determine an M^{th} perturbation value 1009 based on the M^{th} noise prediction loss 1008, so as to determine whether the perturbation threshold condition is satisfied based on the M^{th} perturbation value 1009 and the perturbation threshold 1006. In a case that the perturbation threshold condition is satisfied, the computer device performs perturbation processing on an (M−1)^{th} perturbed image through the M^{th} perturbation value 1009, to obtain an anti-editing image 1010. In a case that the perturbation threshold condition is not satisfied, the computer device performs perturbation processing on the original image 1001 through the perturbation threshold 1006, to obtain the anti-editing image 1010.

In a possible implementation, the computer device determines, based on Monte Carlo simulation and through a diffusion model and the anti-editing algorithm provided in some embodiments of this disclosure, a group of anti-editing image sets corresponding to the original image set including N original images.

The number of times of Monte Carlo simulation is M, the diffusion model is ∈_{\hat{θ}}(xₜ, t, c), the original image set is (I₁, I₂, . . . , Iₙ), and the anti-editing image set is

$$( {I}_{1}^{′} , {I}_{2}^{′} , … , {I}_{n}^{′} ) .$$

Therefore, an algorithm process may be represented as:

For i in range (N)//N original images
cᵢ=BLIP (Iᵢ)//respectively extract text descriptions corresponding to the N original images

For k in range (M)//each original image is simulated M times
∈− [symbol] (0, E), t−U(T)//sample Gaussian noise and determine a sampling

[symbol]

$${x}_{t}^{i} = {a}_{t} {I}_{i} + {σ}_{t} ϵ //$$

a noise-added image corresponding to a moment T in a process of performing noise addition processing on the original image

$$Loss = {‖ {ϵ}_{\hat{θ}} ( {x}_{t}^{i} , t , {c}_{i} ) - ϵ ‖}^{2} //$$

determine the noise prediction loss based on the predicted noise and the sampled noise

$${δ}_{i} = \frac{\partial Loss}{\partial {I}_{i}^{′}} //$$

perform gradient calculation on the noise prediction loss based on the previous perturbed image, to obtain the i^{th} perturbation value

$$Clip ( {‖ {I}_{i}^{′} + {δ}_{i} - {I}_{i} ‖}^{p} , {δ}_{0} ) //$$

determine the perturbation threshold condition for the i^{th} perturbation value

$${I}_{i}^{′} = {I}_{i}^{′} + {δ}_{i} //$$

perform perturbation processing on the (i−1)^{th} perturbed image based on the i^{th} perturbation value

Therefore, the anti-editing image set

$$( {I}_{1}^{′} , {I}_{2}^{′} , … , {I}_{n}^{′} )$$

is outputted.

In some embodiments, considering that the diffusion model may only edit and learn an image feature of a certain region in the image in the process of learning and editing the image feature, for example, the diffusion model may only focus on learning a foreground character feature of the image, a feature of an article in the foreground, or the like, to improve generation efficiency of the anti-editing image, the computer device may further perform, based on the anti-editing degree required by different image regions in the original image, perturbation processing on the original image.

In a possible implementation, the computer device may perform image region division on the original image based on the image feature of the original image, to obtain a plurality of original image regions, where different original image regions correspond to different anti-editing degrees. For example, the anti-editing degree corresponding to the foreground image region is greater than the anti-editing degree corresponding to the background image region.

Further, the computer device may determine a perturbation value corresponding to each of the different original image regions based on the noise prediction loss between the predicted noise and the sampled noise and the anti-editing degrees corresponding to the different original image regions, so as to perform perturbation processing on the original image based on the perturbation value corresponding to each of the different original image regions to obtain the anti-editing image.

In a possible implementation, the computer device may further set an anti-editing level to indicate the anti-editing degree of each original image region. For example, the foreground image region has a high anti-editing level, and the background image region has a low anti-editing level.

In another possible implementation, different anti-editing degrees may be further represented in that different perturbation value adjustments are performed on different original image regions. For example, after the perturbation value δ is determined based on the noise prediction loss, the computer device may directly perform perturbation processing on the foreground image region based on the perturbation value δ, and perform perturbation processing on the background image region based on a half of the perturbation value 0.5 δ.

In another possible implementation, different anti-editing degrees may be further represented in that different rounds of perturbation processing are performed on different original image regions. For example, after the perturbation value in each round is determined, the computer device may perform perturbation processing on the foreground image region based on the perturbation value in each round, and perform perturbation processing on the background image region based on the perturbation value in every five rounds.

In a possible implementation, based on that a visual effect after the original image is converted into an anti-editing image is not affected as far as possible while performing anti-editing processing, the computer device may further perform local perturbation processing on the original image. For example, after the perturbation value is determined based on the noise prediction loss between the predicted noise and the sampled noise, the computer device may perform perturbation processing on the foreground image region of the original image based on the perturbation value corresponding to the foreground image region in the perturbation values. In other words, the computer device may set a perturbation value corresponding to a pixel point of the background image region in the perturbation matrix to zero, to perform perturbation processing on the original image based on the set perturbation value to obtain an anti-editing image.

In the foregoing embodiments, image region division is performed on the original image, to obtain different original image regions. The perturbation value corresponding to each original image region is determined based on the anti-editing degrees corresponding to the different original image regions, and perturbation processing is performed on the original image based on the perturbation value, to obtain the anti-editing image, which implements anti-editing processing while reducing the visual difference between the original image and the anti-editing image, improves efficiency of the anti-editing processing, and optimizes image quality of the anti-editing image.

FIG. 11 is a structural block diagram of an image processing apparatus according to an embodiment of this disclosure. The apparatus includes:
an obtaining module 1101, configured to obtain an original image;
a noise addition processing module 1102, configured to perform noise addition processing on the original image through a forward diffusion network of a diffusion model based on sampled noise, to obtain a noise-added image;
a noise prediction module 1103, configured to perform denoising processing on the noise-added image through a reverse diffusion network of the diffusion model, and determine predicted noise based on a denoised image obtained through the denoising processing;
a perturbation determining module 1104, configured to determine a perturbation value based on a noise prediction loss between the predicted noise and the sampled noise; and
a first perturbation processing module 1105, configured to perform perturbation processing on the original image based on the perturbation value, to obtain an anti-editing image.

In some embodiments, the noise addition processing module 1102 is configured to:
sample standard Gaussian noise to obtain the sampled noise; and
perform noise addition processing on the original image through the forward diffusion network based on the sampled noise and a diffusion duration, to obtain the noise-added image.

In some embodiments, the noise prediction module 1103 is configured to:
sample the diffusion duration to obtain a sampling moment;
perform denoising processing on the noise-added image through the reverse diffusion network, to obtain the denoised image corresponding to the sampling moment; and
perform noise prediction on the denoised image, to obtain the predicted noise.

In some embodiments, the noise prediction module 1103 is further configured to:
perform denoising processing on the noise-added image through the reverse diffusion network based on a text description of the original image, to obtain the denoised image corresponding to the sampling moment.

In some embodiments, the perturbation determining module 1104 is configured to:
perform norm calculation on a noise difference between the predicted noise and the sampled noise, to obtain the noise prediction loss; and
perform gradient calculation on the noise prediction loss based on the original image, to obtain the perturbation value.

In some embodiments, the first perturbation processing module 1105 is configured to:
perform M rounds of perturbation processing on the original image based on the perturbation value, and determining, as the anti-editing image, a perturbed image obtained from an M^{th} round of perturbation processing, M being a positive integer.

In some embodiments, an i^{th} round of perturbation processing among the M rounds of perturbation processing includes:
performing noise addition processing on an (i−1)^{th} perturbed image through the forward diffusion network based on i^{th} sampled noise, to obtain an i^{th} noise-added image, the (i−1)^{th} perturbed image being a perturbed image obtained through an (i−1)^{th} round of perturbation processing, and i being a positive integer greater than 1 and less than or equal to M;
performing denoising processing on the i^{th} noise-added image through the reverse diffusion network, and determining i^{th} predicted noise based on the i^{th} denoised image obtained through denoising;
determining an i^{th} perturbation value based on an i^{th} noise prediction loss between the i^{th} predicted noise and the i^{th} sampled noise;
performing perturbation processing on the (i−1)^{th} perturbed image based on the i^{th} perturbation value to obtain an i^{th} perturbed image if it is determined based on the i^{th} perturbation value and a perturbation threshold that a perturbation threshold condition is satisfied; and
performing perturbation processing on the original image based on the perturbation threshold to obtain the i^{th} perturbed image if it is determined based on the i^{th} perturbation value and the perturbation threshold that the perturbation threshold condition is not satisfied.

In some embodiments, the first perturbation processing module 1105 is further configured to:
perform norm calculation on a noise difference between the i^{th} predicted noise and the i^{th} sampled noise, to obtain the i^{th} noise prediction loss; and
perform gradient calculation on the i^{th} noise prediction loss based on the (i−1)^{th} perturbed image, to obtain the i^{th} perturbation value.

In some embodiments, the apparatus further includes:
a second perturbation processing module, configured to perform perturbation processing on the (i−1)^{th} perturbed image based on the i^{th} perturbation value, to obtain an i^{th} candidate perturbed image;
a difference determining module, configured to determine an i^{th} perturbation difference based on the i^{th} candidate perturbed image and the original image, the i^{th} perturbation difference being configured for representing a visual difference between the i^{th} candidate perturbed image and the original image; and
a norm calculation module, configured to perform norm calculation on the i^{th} perturbation difference, to obtain an i^{th} perturbation norm.

The first perturbation processing module 1105 is configured to: determine the i^{th} candidate perturbed image as the i^{th} perturbed image if the i^{th} perturbation norm is not greater than the perturbation threshold.

The first perturbation processing module 1105 is further configured to:
perform perturbation processing on the original image based on the perturbation threshold to obtain the i^{th} perturbed image if the i^{th} perturbation norm is greater than the perturbation threshold.

In some embodiments, the apparatus further includes:
a training module, configured to train an original diffusion model through a sample image set, to obtain a trained diffusion model, the sample image set including at least a sample image having a similar image feature to the original image.

In some embodiments, the apparatus further includes:
an image division module, configured to perform image region division on the original image based on the image feature of the original image, to obtain a plurality of original image regions, different original image regions among the plurality of original image regions corresponding to different anti-editing degrees.

The perturbation determining module 1104 is configured to:
determine a perturbation value corresponding to each of the different original image regions based on the noise prediction loss between the predicted noise and the sampled noise and the anti-editing degrees corresponding to the different original image regions.

The first perturbation processing module 1105 is further configured to:
perform perturbation processing on the original image based on the perturbation value corresponding to each of the different original image regions, to obtain the anti-editing image.

Based on the above, in some embodiments of this disclosure, after the original image is obtained, the noise addition processing is first performed on the original image through the forward diffusion network of the diffusion model based on the sampled noise, to obtain the noise-added image. Further, the denoising processing is performed on the noise-added image through the reverse diffusion network of the diffusion model, and the predicted noise is determined based on the denoised image obtained through denoising processing. The process in which the diffusion model performs noise addition processing and denoising processing on the original image corresponds to the process of performing image feature learning on the original image. However, the noise prediction loss between the predicted noise and the sampled noise may represent an uncertainty of the diffusion model for the noise in a current state. Therefore, the perturbation value may be determined based on the noise prediction loss between the predicted noise and the sampled noise. The perturbation value is intended to simulate or amplify an uncertainty of the diffusion model in the predicted noise. In this way, perturbation processing may be performed on the original image based on the perturbation value, to obtain an anti-editing image, thereby introducing an additional noise that is difficult to predict into the anti-editing image. In other words, signal interference is applied to each pixel point in the anti-editing image, thereby increasing the difficulty for the diffusion model to learn image feature of the anti-editing image. Correspondingly, in a case that image editing is performed on the anti-editing image through the trained diffusion model, because signal interference is applied to each pixel point in the anti-editing image, the diffusion model cannot accurately extract the image feature in the anti-editing image, thereby enhancing difficulty for the diffusion model to edit the anti-editing image.

The apparatus provided in the foregoing embodiment is illustrated only with an example of division of the foregoing function modules. In practical applications, the foregoing functions may be allocated to and completed by different function modules according to requirements. In other words, the internal structure of the apparatus is divided into different function modules to complete all or some of the functions described above. In addition, the apparatus provided in the foregoing embodiments and the method embodiments belong to the same concept. For details of an implementation process, reference may be made to the method embodiments. Details are not described herein again.

In this disclosure, a prompt interface and a pop-up window may be displayed or voice prompt information may be outputted before and during the process of collecting relevant user data such as the original image. The prompt interface, the pop-up window, or the voice prompt information is configured for prompting the user that user-related data is currently being acquired. In this way, in this disclosure, related operations of obtaining the user-related data only start to be executed after obtaining a confirmation operation of the user on the prompt interface or the pop-up window. Otherwise (i.e., when the confirm operation performed by the user on the prompt interface or the pop-up window is not obtained), the related operations of obtaining the user-related data are ended. In other words, the user-related data is not obtained.

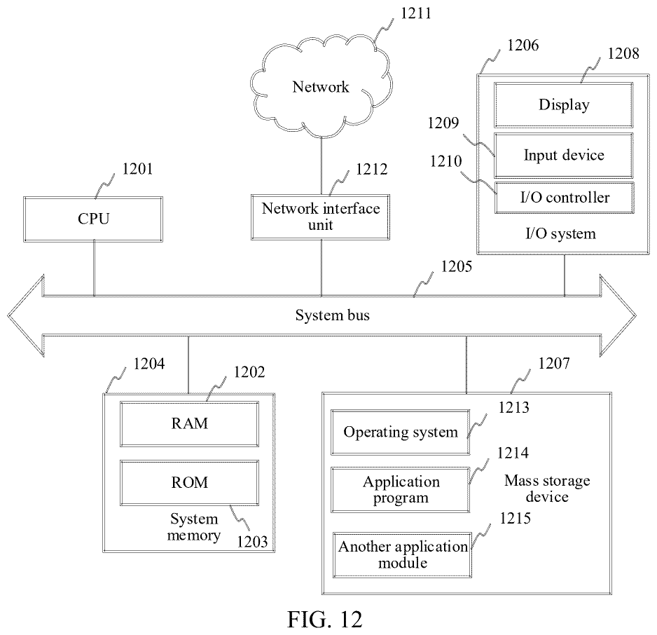

FIG. 12 is a schematic structural diagram of a computer device according to an embodiment of this disclosure. Specifically, the computer device 1200 includes processing circuitry (e.g., a central processing unit (CPU) 1201), a system memory 1204 including a random access memory (RAM) 1202 and a read-only memory (ROM) 1203, and a system bus 1205 connecting the system memory 1204 and the central processing unit 1201. The computer device 1200 further includes a basic input/output (I/O) system 1206 assisting in information transmission between devices in the computer, and a mass storage device 1207 configured to store an operating system 1213, an application program 1214, and another program module 1215.

The basic I/O system 1206 includes a display 1208 configured to display information and an input device 1209 such as a mouse or a keyboard for a user to input information. The display 1208 and the input device 1209 are both connected to the CPU 1201 through an I/O controller 1210 connected to the system bus 1205. The basic I/O system 1206 may further include the I/O controller 1210 to receive and process inputs from a plurality of other devices such as a keyboard, a mouse, or an electronic stylus. Similarly, the I/O controller 1210 further provides an output to a display screen, a printer, or another type of output device.

The mass storage device 1207 is connected to the CPU 1201 through a mass storage controller (not shown) connected to the system bus 1205. The mass storage device 1207 and a computer-readable medium associated with the mass storage device provide non-volatile storage for the computer device 1200. In other words, the mass storage device 1207 may include a non-transitory computer-readable medium such as a hard disk or a drive.

Without loss of generality, the mass storage device 1207 may include volatile and non-volatile media, and removable and non-removable media implemented by using any method or technology configured for storing information such as computer-readable instructions, data structures, program modules, or another data. The mass storage device 1207 may include a RAM, a ROM, a flash memory or another solid-state storage technology, a compact disc read-only memory (CD-ROM), a digital versatile disc (DVD) or another optical memory, a magnetic cassette, a magnetic tape, or another magnetic storage device. Certainly, a person skilled in the art may learn that the computer storage medium included in the mass storage device 1207 is not limited to the foregoing several types. The foregoing system memory 1204 and the mass storage device 1207 may be collectively referred to as a memory.

The memory has one or more programs stored therein, the one or more programs being configured to be executed by one or more CPUs 1201, and the one or more programs including instructions for implementing the foregoing method. The CPU 1201 executes the one or more programs to implement the method provided in the foregoing method embodiments.

According to some embodiments of this disclosure, the computer device 1200 may be further connected to a remote computer on a network for running through a network such as the Internet. In other words, the computer device 1200 may be connected to a network 1211 through a network interface unit 1212 connected to the system bus 1205, or may be connected to another type of network or a remote computer system (not shown) through the network interface unit 1212.

An embodiment of this disclosure further provides a non-transitory computer-readable storage medium, having at least one instruction stored therein, the at least one instruction being loaded and executed by processing circuitry (such as a processor) to implement the image processing method provided in the foregoing method embodiments.

In some embodiments, the non-transitory computer-readable storage medium may include a ROM, a RAM, a solid state drive (SSD), an optical disc, and the like. The RAM may include a resistance random access memory (ReRAM) and a dynamic random access memory (DRAM).

An embodiment of this disclosure provides a computer program product, the computer program product including a computer instruction, the computer instruction being stored in a non-transitory computer-readable storage medium. Processing circuitry, such as a processor, of a computer device reads the computer instruction from the computer-readable storage medium, and the processor executes the computer instruction, so that the computer device performs the image processing method in the foregoing embodiments.

A person of ordinary skill in the art may understand that all or part of the operations of implementing the foregoing embodiments may be implemented by hardware, or may be implemented by a program instructing related hardware. The program may be stored in a non-transitory computer-readable storage medium. The foregoing storage medium may be a ROM, a magnetic disk, an optical disc, or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., a computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions correspond to non-limiting embodiments of this disclosure, and are not intended to limit this disclosure. Any modification, equivalent replacement, or improvement made within the spirit and principle of this disclosure are within the scope of this disclosure.

What is claimed is:

1. An image processing method, comprising:
obtaining an original image;
obtaining, by processing circuitry, a noise-added image through application of a forward diffusion network of a diffusion model to the original image based on sampled noise;
obtaining, by the processing circuitry, a denoised image through application of a reverse diffusion network of the diffusion model to the noise-added image;
determining predicted noise based on the denoised image;
determining a perturbation value based on a noise prediction loss between the predicted noise and the sampled noise; and
obtaining, by the processing circuitry, an anti-editing image through perturbation processing on the original image based on the perturbation value and a perturbation threshold.

2. The method according to claim 1, wherein the obtaining the noise-added image comprises:
obtaining the sampled noise based on sampling standard Gaussian noise; and
obtaining the noise-added image through the application of the forward diffusion network based on the sampled noise and a diffusion duration.

3. The method according to claim 2, wherein the obtaining the denoised image comprises:
obtaining a sampling moment based on sampling the diffusion duration; and
obtaining the denoised image corresponding to the sampling moment through the application of the reverse diffusion network.

4. The method according to claim 3, wherein the obtaining the denoised image corresponding to the sampling moment comprises:
obtaining the denoised image corresponding to the sampling moment through the application of the reverse diffusion network based on a text description of the original image.

5. The method according to claim 1, wherein the determining the perturbation value comprises:
obtaining the noise prediction loss based on a norm calculation of a noise difference between the predicted noise and the sampled noise; and
obtaining the perturbation value based on a gradient calculation of the noise prediction loss with respect to the original image.

6. The method according to claim 1, wherein the obtaining the anti-editing image comprises:
performing M rounds of perturbation processing on the original image based on the perturbation value, M being a positive integer; and
determining a resulting perturbed image from an M-th round of perturbation processing of the M rounds of perturbation processing as the anti-editing image.

7. The method according to claim 6, wherein an i-th round of perturbation processing among the M rounds of perturbation processing comprises:
obtaining an i-th noise-added image through application of the forward diffusion network to an (i−1)-th perturbed image based on i-th sampled noise, the (i−1)-th perturbed image being a perturbed image obtained through an (i−1)-th round of perturbation processing, and i being a positive integer greater than 1 and less than or equal to M;
obtaining an i-th denoised image through application of the reverse diffusion network of the diffusion model to the i-th noise-added image;
determining i-th predicted noise based on the i-th denoised image;
determining an i-th perturbation value based on an i-th noise prediction loss between the i-th predicted noise and the i-th sampled noise;
obtaining an i-th perturbed image through perturbation processing on the (i−1)-th perturbed image based on the i-th perturbation value when the i-th perturbation value and the perturbation threshold satisfying a perturbation threshold condition; and
obtaining the i-th perturbed image through perturbation processing on the original image based on the perturbation threshold when the i-th perturbation value and the perturbation threshold do not satisfy the perturbation threshold condition.

8. The method according to claim 7, wherein the determining the i-th perturbation value comprises:
obtaining the i-th noise prediction loss based on a norm calculation of a noise difference between the i-th predicted noise and the i-th sampled noise; and
obtaining the i-th perturbation value based on a gradient calculation of the i-th noise prediction loss with respect to the (i−1)-th perturbed image.

9. The method according to claim 7, further comprising:
obtaining an i-th candidate perturbed image through perturbation processing on the (i−1)-th perturbed image based on the i-th perturbation value;
determining an i-th perturbation difference based on the i-th candidate perturbed image and the original image, the i-th perturbation difference representing a visual difference between the i-th candidate perturbed image and the original image;
obtaining an i-th perturbation norm based on a norm calculation of the i-th perturbation difference;
determining the i-th perturbation value and the perturbation threshold satisfy the perturbation threshold condition when the i-th perturbation norm is not greater than the perturbation threshold; and
determining the i-th perturbation value and the perturbation threshold do not satisfy the perturbation threshold condition when the i-th perturbation norm is greater than the perturbation threshold.

10. The method according to claim 1, further comprising:
obtaining the diffusion model based on training an original diffusion model through a sample image set, the sample image set including at least a sample image having a similar image feature to the original image.

11. The method according to claim 1, further comprising:
obtaining a plurality of original image regions through dividing the original image based on an image feature of the original image, different original image regions among the plurality of original image regions corresponding to different anti-editing degrees,
wherein:
the determining the perturbation value includes determining a perturbation value corresponding to each of the different original image regions based on the noise prediction loss between the predicted noise and the sampled noise and the anti-editing degrees corresponding to the different original image regions, and
the obtaining the anti-editing image includes performing perturbation processing on the original image based on the perturbation value corresponding to each of the different original image regions.

12. An image processing apparatus, comprising:
processing circuitry configured to:
obtain an original image;
obtain a noise-added image through application of a forward diffusion network of a diffusion model to the original image based on sampled noise;
obtain a denoised image through application of a reverse diffusion network of the diffusion model to the noise-added image;
determine predicted noise based on the denoised image;
determine a perturbation value based on a noise prediction loss between the predicted noise and the sampled noise; and
obtain an anti-editing image through perturbation processing on the original image based on the perturbation value and a perturbation threshold.

13. The apparatus according to claim 12, wherein, to obtain the noise-added image, the processing circuitry is configured to:
obtain the sampled noise based on sampling standard Gaussian noise; and
obtain the noise-added image through the application of the forward diffusion network based on the sampled noise and a diffusion duration.

14. The apparatus according to claim 13, wherein, to obtain the denoised image, the processing circuitry is configured to:
obtain a sampling moment based on sampling the diffusion duration; and
obtain the denoised image corresponding to the sampling moment through the application of the reverse diffusion network based on a text description of the original image.

15. The apparatus according to claim 12, wherein, to determine the perturbation value, the processing circuitry is configured to:
obtain the noise prediction loss based on a norm calculation of a noise difference between the predicted noise and the sampled noise; and
obtain the perturbation value based on a gradient calculation of the noise prediction loss with respect to the original image.

16. The apparatus according to claim 12, wherein, to obtain the anti-editing image, the processing circuitry is configured to:
perform M rounds of perturbation processing on the original image based on the perturbation value, M being a positive integer; and
determine a resulting perturbed image from an M-th round of perturbation processing of the M rounds of perturbation processing as the anti-editing image.

17. The apparatus according to claim 16, wherein, to perform an i-th round of perturbation processing among the M rounds of perturbation processing, the processing circuitry is configured to:
obtain an i-th noise-added image through application of the forward diffusion network to an (i−1)-th perturbed image based on i-th sampled noise, the (i−1)-th perturbed image being a perturbed image obtained through an (i−1)-th round of perturbation processing, and i being a positive integer greater than 1 and less than or equal to M;
obtain an i-th denoised image through application of the reverse diffusion network of the diffusion model to the i-th noise-added image;
determine i-th predicted noise based on the i-th denoised image;
determine an i-th perturbation value based on an i-th noise prediction loss between the i-th predicted noise and the i-th sampled noise;
obtain an i-th perturbed image through perturbation processing on the (i−1)-th perturbed image based on the i-th perturbation value when the i-th perturbation value and the perturbation threshold satisfying a perturbation threshold condition; and
obtain the i-th perturbed image through perturbation processing on the original image based on the perturbation threshold when the i-th perturbation value and the perturbation threshold do not satisfy the perturbation threshold condition.

18. The apparatus according to claim 17, wherein the processing circuitry is configured to:
obtain an i-th candidate perturbed image through perturbation processing on the (i−1)-th perturbed image based on the i-th perturbation value;
determine an i-th perturbation difference based on the i-th candidate perturbed image and the original image, the i-th perturbation difference representing a visual difference between the i-th candidate perturbed image and the original image;
obtain an i-th perturbation norm based on a norm calculation of the i-th perturbation difference;
determine the i-th perturbation value and the perturbation threshold satisfy the perturbation threshold condition when the i-th perturbation norm is not greater than the perturbation threshold; and
determine the i-th perturbation value and the perturbation threshold do not satisfy the perturbation threshold condition when the i-th perturbation norm is greater than the perturbation threshold.

19. The apparatus according to claim 12, wherein the processing circuitry is configured to:
obtain a plurality of original image regions through dividing the original image based on an image feature of the original image, different original image regions among the plurality of original image regions corresponding to different anti-editing degrees;
determine a perturbation value corresponding to each of the different original image regions based on the noise prediction loss between the predicted noise and the sampled noise and the anti-editing degrees corresponding to the different original image regions; and
perform perturbation processing on the original image based on the perturbation value corresponding to each of the different original image regions.

20. A non-transitory computer-readable storage medium storing instructions, which when executed by a processor, cause the processor to perform an image processing method comprising:
obtaining an original image;
obtaining a noise-added image through application of a forward diffusion network of a diffusion model to the original image based on sampled noise;
obtaining a denoised image through application of a reverse diffusion network of the diffusion model to the noise-added image;
determining predicted noise based on the denoised image;
determining a perturbation value based on a noise prediction loss between the predicted noise and the sampled noise; and
obtaining an anti-editing image through perturbation processing on the original image based on the perturbation value and a perturbation threshold.
